(19) United States
(12) Patent Application Publication
(10) Pub. No.: US 2012/0098263 A1
(43) Pub. Date: Apr. 26, 2012

(54) WIND ENERGY PLANT AND DRIVE DEVICE FOR ADJUSTING A ROTOR BLADE

(76) Inventors: Volker Kreidler, Hechingen (DE); Rolf-Jürgen Steinigeweg, Herzogenaurach (DE)

(21) Appl. No.: 13/264,557

(22) PCT Filed: Mar. 5, 2010
(86) PCT No.: PCT/EP2010/052810

§ 371 Date: Jan. 4, 2012

(30) Foreign Application Priority Data
Apr. 14, 2009 (DE) 10 2009 017 028.6

(51) Int. Cl. H02P 9/04

(52) U.S. Cl. 290/44

(57) ABSTRACT

The invention relates to a wind energy plant comprising a rotor having a rotor hub which is mounted on a gondola and a plurality of rotor blades. An electric generator is connected to the rotor. The invention also relates to an electric drive device which is designed as a direct drive and used to adjust a rotor blade which is arranged in a concentric manner on the rotor hub in relation to rotor blade bearing and a permanently excited synchronous motor. A stator of the synchronous motor comprises a coil body which is mounted on the motor hub. A rotor of the synchronous motor is arranged at an axial distance with respect to the stator for forming an axially extending air gap. Said rotor also comprises a permanent magnet arrangement on a support plate which is connected to a rotor blade shaft.

Wind energy plants are used for converting kinetic energy of wind into electrical energy by means of a rotor in order to feed said electrical energy into an electrical energy transmission system, for example. Motive energy of a wind flow acts on rotor blades which are mounted on a rotor hub and are set in rotary motion in the event of a wind flow. The rotary motion is transmitted directly or by means of a transmission to a generator, which converts the motive energy into electrical energy. A drive train comprising the generator is arranged in a pod mounted on a tower in conventional wind energy plants.

Rotor blades of wind energy plants have an aerodynamic profile, which brings about a pressure difference which is caused by a difference in the flow rate between the intake and pressure sides of a rotor blade. This pressure difference results in a torque acting on the rotor, said torque influencing the speed of said rotor.

Wind energy plants have predominantly a horizontal axis of rotation. In such wind energy plants, wind direction tracking of the pod generally takes place by means of servomotors. In this case, the pod which is connected to the tower via an azimuth bearing is rotated about the axis thereof.

Rotors with 3 rotor blades have caught on more than single-blade, twin-blade or four-blade rotors since three-blade rotors are easier to manage in terms of oscillations. In the case of rotors with an even number of rotor blades, tipping forces acting on a rotor blade as a result of slipstream effects are reinforced by a rotor blade which is opposite and is offset through 180°, which results in increased demands being placed on the mechanics and material. Rotors with 5 or 7 rotor blades result in aerodynamic states which can be described mathematically in relatively complicated fashion since air flows on the rotor blades influence one another. In addition, such rotors do not enable any increases in performance which are economically viable in terms of their relationship to the increased complexity involved in comparison with rotors with 3 rotor blades.

Wind energy plants often have pitch drive systems for rotor blade adjustment. The flow rate differences between the intake and pressure sides of the rotor blades are altered by the adjustment of the angle of attack of the rotor blades. In turn, this influences the torque acting on the rotor and the rotor speed.

In conventional wind energy plants, a rotor blade adjustment takes place via a hydraulically actuated cylinder or via an electric motor or geared motor. In the case of motor-operated adjustment, an output drive pinion meshes with a toothed ring, which surrounds a rotor blade and is connected thereto in the region of a bearing ring. WO 2005/019642 has disclosed a pitch drive system which has a gearless direct drive, the rotor and stator of which are arranged concentrically one inside the other in one plane. This pitch drive system has a disadvantage, however, that the rotor and the stator need to be matched to the respective rotor blade in terms of their dimensions. This restricts the use possibilities of the pitch drive system known from WO 2005/019642 for different rotor blade sizes considerably.

The present invention is based on the object of providing a wind energy plant, whose pitch drive system can be used for different rotor blade sizes and enables rapid and precise rotor blade adjustment as well as specifying system components suitable for this purpose.

This object is achieved according to the invention by a wind energy plant having the features specified in claim 1 and by a drive device having the features specified in claim 11. Advantageous developments of the present invention are specified in the dependent claims.

The wind energy plant according to the invention has a rotor, which comprises a rotor hub which is mounted on a pod and a plurality of rotor blades. An electrical generator is connected to the rotor. Furthermore, in each case one electrical drive device in the form of a direct drive is provided for adjusting a rotor blade, said drive device being arranged concentrically with respect to a rotor blade bearing on the rotor hub and comprising a permanent magnet synchronous motor. A stator of the synchronous motor comprises a coil former mounted on the rotor hub. A rotor of the synchronous motor is arranged at an axial distance from the stator so as to form an axially extending air gap. In addition, the rotor has a permanent magnet arrangement on a carrier plate, which is connected to a rotor blade shaft.

By using a direct drive system with a permanent magnet synchronous motor and by saving on mechanical components requiring maintenance, a wear-free, more precise and more dynamic individual blade adjustment is achieved according to the invention in comparison with conventional pitch drive systems. One embodiment of the synchronous motor with a layered configuration makes it possible to use said synchronous motor for a large number of rotor blade sizes and also enables simple mounting, since the rotor and stator can be handled separately. A further simplification of the mounting can be achieved if both the rotor and the stator are each divided into modules in the form of segments of a circle which together form the rotor or stator.

Corresponding to a preferred development of the present invention, the rotor and stator of the synchronous motor are arranged in separate planes and surround the rotor blade bearing. This enables particularly space-saving arrangement of a pitch drive system. Furthermore, the synchronous motor can be in the form of a segment motor, for example, and the permanent magnet arrangement can comprise permanent magnets which are arranged in segments on the carrier plate and interact with coils of the coil former which are arranged in segments. This enables inexpensive production of a pitch drive system using a large number of identical component parts.

In order to maintain its adjustment, in accordance with a further advantageous configuration of the present invention, a rotor blade can be locked by means of a wedge mechanism, which comprises a friction body which can be actuated by means of a first and second wedge body. The first and second wedge bodies in this case each have bearing faces which interact with one another. In addition, a locking element is provided which is connected to the rotor blade and is capable of rotating therewith about the axis of said rotor blade. The friction body exerts a contact-pressure force on the locking element in the event of a relative movement between the first and second wedge bodies. By means of the wedge mechanism, a rotor blade can be locked in terms of its adjustment in a simple and safe manner. As an alternative to a wedge mechanism, a rotor blade can be fixed in a secure 90° position by means of a conical index bolt which can be unlocked electromagnetically.

The present invention will be explained in more detail below using an exemplary embodiment with reference to the drawing, in which:

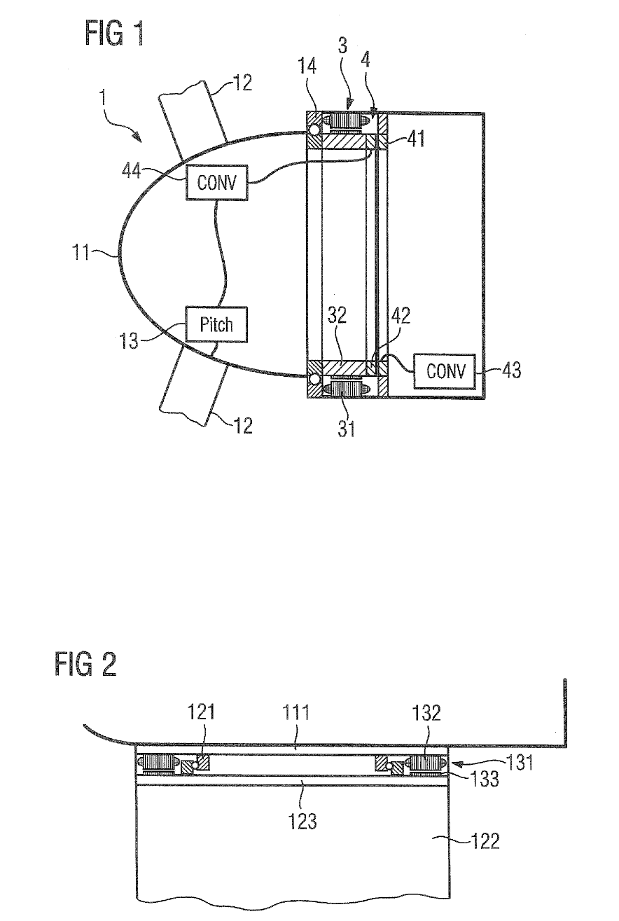

FIG. 1 shows a schematic illustration of a wind energy plant with a pitch drive system according to the invention,

FIG. 2 shows a detail illustration of the pitch drive system of the wind energy plant shown in FIG. 1,

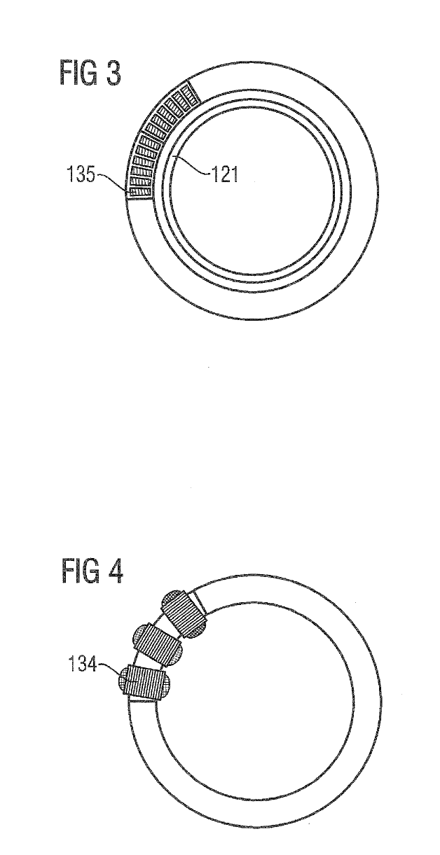

FIG. 3 shows a detail illustration of a rotor of the pitch drive system shown in FIG. 2,

FIG. 4 shows a detail illustration of a stator of the pitch drive system shown in FIG. 2,

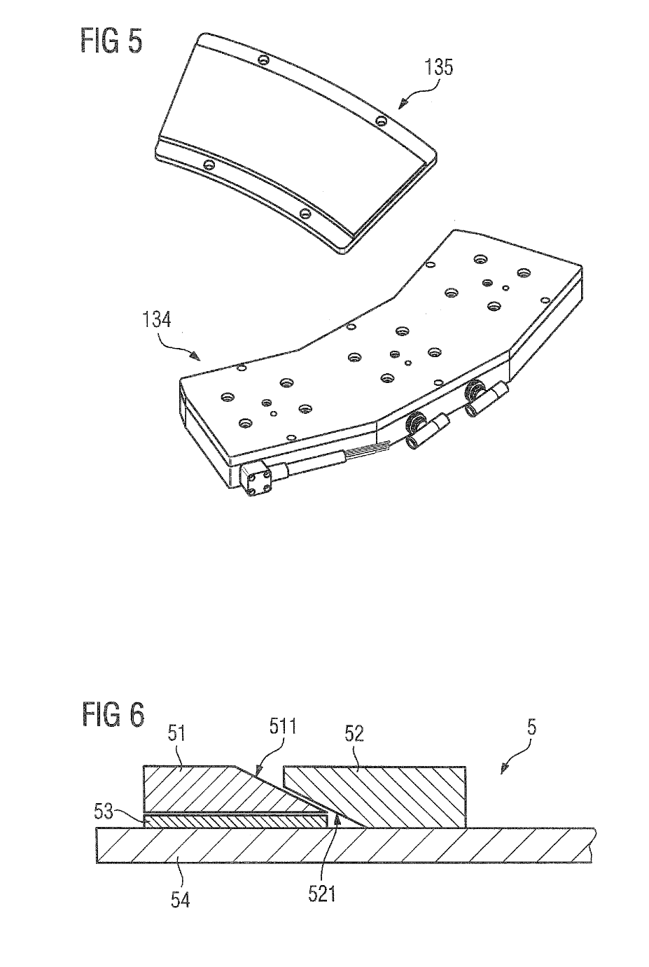

FIG. 5 shows segments of a rotor and a stator as shown in FIGS. 3 and 4, in a perspective illustration,

FIG. 6 shows a detail illustration of a locking apparatus for the pitch drive system shown in FIG. 2.

The wind energy plant illustrated in FIG. 1 has a rotor 1, which comprises a rotor hub 11 mounted on a pod 2 and a plurality of rotor blades 12, which can each be adjusted by means of a separate pitch system 13. A rotor 32 of an electrical generator 3 is capable of rotating with the rotor hub 11 and is integrated therein. A rotor bearing 14 adjoins a stator 31 of the generator 3.

Furthermore, the wind energy plant illustrated in FIG. 1 has an energy transmission device 4, which comprises a rotary transformer, which is arranged concentrically with respect to the rotor bearing 14, for supplying energy to the pitch system 13 arranged in the rotor hub 11. An annular primary part 41 of the rotary transformer is connected to the pod 2 via the rotor bearing 14. The primary part 41 and the rotor bearing 14 can be combined to form an integrated system component. In addition, the rotary transformer comprises an annular secondary part 42, which is connected to the rotor hub 11 and is capable of rotating therewith. The secondary part 42 is arranged adjacent to a rotor winding of the generator 3 and concentrically with respect thereto.

In order to generate a high-frequency field voltage from a low-frequency supply voltage, a first frequency converter 43 is provided, which is connected between the primary part 43 and a supply voltage source (not illustrated explicitly in FIG. 1). The energy transmission device 4 furthermore comprises a second frequency converter 44 for generating a low-frequency load voltage from a high-frequency transformed field voltage. The second frequency converter 44 is connected between the secondary part 42 and the pitch system 13.

Instead of a second frequency converter, a rectifier for generating a DC voltage from a high-frequency transformed field voltage can be provided, said rectifier being connected between the secondary part and the electrical loads in the rotor hub. Furthermore, the rotary transformer can be part of a transmission, which connects the rotor to the generator, and can provide a high-frequency AC voltage via an electrical plug-type connection at a rotor-side transmission shaft end.

The primary part 41 and the secondary part 42 of the rotary transformer of the wind energy plant illustrated in FIG. 1 are arranged so as to be axially spaced apart in separate planes and have substantially the same diameter. An air gap in the rotary transformer, in which a high-frequency electromagnetic field is induced by the field voltage, extends axially between the primary part 41 and the secondary part 42. In principle, the primary part and the secondary part could also be arranged concentrically one inside the other in a common plane, and the air gap in the rotary transformer could extend radially between the primary part and the secondary part.

Control and status signals from and to the pitch system 13 can also be transmitted via the rotary transformer. As an alternative to this, the control and status signals can also be transmitted via a WLAN link or a suitable other radio link.

Corresponding to the detail illustration of the pitch system 13 in the form of an electrical direct drive in FIG. 2, a permanent magnet synchronous motor 131 is provided, which is arranged concentrically with respect to a rotor blade bearing 121 on the rotor hub 11. A stator 132 of the synchronous motor 131 comprises a coil former which can be mounted on a ring 111 of the rotor hub 11. A rotor 133 of the synchronous motor 131 is arranged at an axial distance from the stator 132 so as to form an axially extending air gap and has a permanent magnet arrangement on a carrier ring 123, which is connected to a rotor blade shaft 122. The rotor 133 and the stator 132 of the synchronous motor 131 are arranged in separate planes and surround the rotor blade bearing 121.

It can be seen from the detail illustrations in FIGS. 3 and 4 that the synchronous motor 131 is in the form of a segment motor (see also FIG. 5). The permanent magnet arrangement comprises permanent magnets 135 which are arranged in segments on the carrier ring 123 around the rotor blade bearing 121 and which interact with coils 134 of the coil former 132 arranged in segments.

In order to fix an adjustment of a rotor blade, the locking apparatus 5 illustrated in FIG. 6 is provided. The locking apparatus 5 comprises a friction body 53 which can be actuated by means of a first wedge body 51 and a second wedge body 52. The first wedge body 51 and the second wedge body 52 each have bearing faces 511, 521 which interact with one another. In addition, the locking apparatus comprises a locking element 54, which is connected to the rotor blade and is capable of rotating therewith about the axis of said rotor blade and which can be integrally formed on the carrier ring 123 or integrated therein, for example. The friction body 53 exerts a contact-pressure force on the locking element 54 when the two wedge bodies are moved towards one another or when one wedge body is moved in the direction of the other wedge body and the other wedge body is fixed.

The application of the invention is not restricted to the above exemplary embodiments.

What is claimed is:

1.-11. (canceled)

12. A wind energy plant comprising:
a rotor having a rotor hub mounted on a pod and a plurality of rotor blades having corresponding rotor blade shafts,
an electrical generator connected to the rotor, and
an electrical drive device in form of a direct drive operatively connected with each of the rotor blades in one-to-one correspondence for adjusting the rotor blade, said electrical drive device being arranged concentrically with respect to a rotor blade bearing arranged on the rotor hub and comprising a permanent magnet synchronous motor having a stator comprising a coil former mounted on the rotor hub and a rotor being arranged at an axial distance from the stator so as to form an axially extending air gap, with the stator having a permanent magnet arrangement disposed on a carrier plate connected to the rotor blade shaft.

13. The wind energy plant of claim 12, wherein the rotor and the stator of the synchronous motor are arranged in separate planes and surround the rotor blade bearing.

14. The wind energy plant of claim 12, wherein the synchronous motor is embodied as a segment motor, with the permanent magnets comprising permanent magnets arranged in segments on the carrier plate and interacting with coils of the coil former also arranged in segments.

15. The wind energy plant of claim 12, comprising:
a locking element connected to the rotor blade and co-rotating with the rotor blade about an axis of the rotor blade, and
a wedge mechanism for locking a rotor blade so as to maintain adjustment of the rotor blade, the wedge mechanism comprising a friction body, a first wedge body and a second wedge body, said first and second wedge bodies each have cooperating bearing faces and operate the friction body,
wherein the friction body exerts a contact pressure on the locking element in response to a relative movement between the first wedge body and the second wedge body.

16. The wind energy plant of claim 12, further comprising:
a rotary transformer arranged concentrically with respect to a rotor bearing for supplying energy to the drive device for adjusting a rotor blade, with the rotary transformer comprising a primary part connected to the pod and a secondary part arranged in the rotor hub for co-rotation with the rotor hub,
a first frequency converter connected between the primary part and a supply voltage source and generating a high-frequency field voltage from a low-frequency supply voltage, and
a second frequency converter connected between the secondary part and the electrical loads in the rotor hub and generating a low-frequency load voltage from a high-frequency transformed field voltage.

17. The wind energy plant of claim 12, wherein the electrical generator comprises a generator rotor which co-rotates with the rotor hub.

18. The wind energy plant of claim 17, wherein a winding of the electrical generator rotor adjoins the secondary part of the rotary transformer.

19. The wind energy plant of claim 12, wherein the primary part and the secondary part are arranged concentrically, one inside the other, in a common plane, and wherein an air gap of the rotary transformer extends radially between the primary part and the secondary part.

20. The wind energy plant of claim 12, wherein the primary part and the secondary part are arranged in separate planes with an axial offset, and wherein an air gap of the rotary transformer extends axially between the primary part and the secondary part.

21. The wind energy plant of claim 16, further comprising a rotor bearing, wherein the rotary transformer is integrated in the rotor bearing.

22. A drive device for adjusting a rotor blade of a wind energy plant, comprising:
a permanent magnet synchronous motor arranged on a rotor hub concentrically with respect to a rotor blade bearing and having a stator comprising a coil former mounted on the rotor hub and a rotor being arranged at an axial distance from the stator so as to form an axially extending air gap, with the stator having a permanent magnet arrangement disposed on a carrier plate connected to the rotor blade shaft,
wherein the drive device is embodies as an electrical direct drive.
